(19) United States
(12) Patent Application Publication
(10) Pub. No.: US 2006/0257203 A1
(43) Pub. Date: Nov. 16, 2006

(54) Joint connecting clip and joint connecting structure

(75) Inventor: Shuhei Iida, Tokyo (JP)

Correspondence Address: Norris, McLaughlin & Marcus P.A., 18th Floor, 875 Third Avenue, New York, NY, 10022, US

(73) Assignee: Toflo Corporation, Tokyo (JP)

(21) Appl. No.: 11/284,067

(22) Filed: Nov. 21, 2005

(30) Foreign Application Priority Data
Apr. 26, 2005 (JP) 2005-128697

(51) Int. Cl. B25G 3/00

(52) U.S. Cl. 403/300

(57) ABSTRACT

There are provided a joint connecting clip which can be removed easily with access from one direction only, thereby having excellent removing workability, is provided with rotation preventive means to prevent a joint from turning and also can be provided with a locking mechanism to prevent the clip from being removed easily, and is suitable for obtaining a compact piping configuration, and a joint connecting structure having the said joint connecting clip. The construction of a joint connecting clip 1 is such that a pair of handling portions 11 are provided above gripping portions 10, and the gripping portions 10 are opened and closed with access of only one direction by an operation of pinching the handling portions 11 from upper both sides of the gripping portions 10. The operation of pinching the paired handling portions 11 can be performed satisfactorily, for example, with the thumb and the forefinger of one hand, so that the joint connecting clip 1 can be removed easily with one hand. Since the gripping portions 10 can be opened by a one-hand operation performed from the upside of the gripping portions 10, there is no need for securing a space, which is necessary for removing the joint connecting clip 1, on both sides of the joint connecting clip 1.

### BACKGROUND OF THE INVENTION

1. Field of the Invention

The present invention relates to a joint connecting clip used when two joints are connected and a joint connecting structure using the same joint connecting clip.

2. Description of the Related Art

Conventionally, as a joint connecting clip of this type, a joint connecting clip having a construction as disclosed, for example, in Japanese Patent Laid-Open No. 2003-28368 has been known. A joint connecting clip (locking body) (1) described in the Japanese Patent Laid-Open No. 2003-28368 has a construction such that one plate material having suitable elasticity is bent into a C shape to form the clip (1) (refer to Paragraph 0010 of the Japanese Patent Laid-Open No. 2003-28368), and when a connecting pipe (5) is connected to a pipe to be connected (6), both lower skirt portions (34) at both ends of the C shape are opened toward both sides of right and left to mount the clip (1). Reference numerals in the parentheses are those used in the Japanese Patent Laid-Open No. 2003-28368. The same is true in the description below.

However, the joint connecting clip (1) having the above-described conventional construction is constructed so that both of the lower skirt portions (34) are opened toward both sides of right and left to mount the clip (1) to the connecting portion. Therefore, the clip removing access direction at the time when the already mounted joint connecting clip (1) is removed is the both sides of right and left or the rear of the joint connecting clip (1), so that when the joint connecting clip (1) is removed, both of the skirt portions (34) must be gripped and opened with both hands by inserting both hands, for example, from both sides of the joint connecting clip (1). Therefore, it is difficult to easily remove the joint connecting clip (1) with one hand.

In particular, in the case where there is no enough space for hands to be inserted on both sides of the joint connecting clip (1), since the skirt portions (34) cannot be gripped with both hands, the joint connecting clip (1) cannot sometimes be removed even if both hands are used.

Also, for the joint connecting clip (1) having the above-described conventional construction, in order for the clip (1) to be removed, an enough space for hands to be inserted must always be secured on both sides of the joint connecting clip (1). Therefore, when it is attempted to use the joint connecting clip (1) having the above-described construction in an area in which a plurality of pipes are closely arranged in parallel as is often seen in a plant, for example, the joint connecting clips (1) must be arranged in a zigzag form as measures for securing an enough space for hands to be inserted on both sides of the joint connecting clip (1). This complicates the arrangement configuration of clip connecting clips. Also, even if the joint connecting clips (1) are arranged in a zigzag form, since the joint connecting clip (1) having the above-described construction always requires the aforementioned space on both sides, a plurality of pipes cannot be arranged closely in parallel, which poses a problem in that a compact pipe arrangement cannot be adopted.

Further, the joint connecting clip (1) having the above-described conventional construction has no locking mechanism. Therefore, there arises a problem in that the joint connecting clip (1) may be removed easily by a person unconcerned, or the joint connected by the joint connecting clip (1) may turn.

### SUMMARY OF THE INVENTION

The present invention has been made to solve the above problems, and accordingly an object of the present invention is to provide a joint connecting clip and a joint connecting structure which can be removed easily with access from one direction only, thereby having excellent removing workability.

Another object of the present invention is to provide a joint connecting clip and a joint connecting structure which prevent relative turning between the connected joints.

Another object of the present invention is to provide a joint connecting clip and a joint connecting structure which prevent the clip from wrong removing.

Another object of the present invention is to provide a joint connecting clip and a joint connecting structure which is suitable for obtaining a compact piping configuration.

To achieve the above object, (1) the present invention provides a joint connecting clip for connecting a pair of joints (50,60) which are arranged to butt against each other at a flange portion (52,62) of the joints, holding the butted flange portions therein, comprising: gripping portions (10) arranged to surround and hold the flange portions of the joints therebetween; engagement portions (12,13) to engage with the outer peripheries of the flange portions when the gripping portions surround and hold the flange portions, at least one of the engage portions having two opening holes (121,122) which is divided by a bridge (120), each of the opening holes engaging with a pair of sprockets (56A,64A) respectively formed on peripheries of the flange portions, and the bridge engaging with the concave portions (56B,64B) between the adjacent sprockets on the flange, for preventing joint relative turning; forcing means (5) for always forcing the gripping portions in the holding direction; and a pair of handling portions (11) integrally formed with the gripping portions, for opening the gripping portions against the force of the forcing means apart from the flange portions, by a pinching operation thereon with only-one-direction access from the upside of the gripping portions.

(2) The present invention also provides a joint connecting clip for connecting a pair of joints (50,60) which are arranged to butt against each other at a flange portion (52,62) of the joints, holding the butted flange portions therein, comprising: a bent plate (21) made of spring material which forms the joint connecting clip body, the bent plate comprising gripping portions (10) arranged to surround and hold the flange portions of the joints therebetween by elastic deformation of the bent plate of spring material, engagement portions (12,13) to engage with the outer peripheries of the flange portions when the gripping portions surround and hold the flange portions, and a pair of mounting holes (24,214,215) provided above the gripping portions; and a pair of handling members (22,23) which are respectively inserted and mounted in the mounting holes detachably, for opening the gripping portions by a pinching operation thereon with only-one-direction access from the upside of the gripping portions.

In the joint connecting clip in accordance with the present invention of the above item (1), the joint connecting clip may further comprises open-operation obstructing means (14) for obstructing opening operation of the gripping portions.

In the joint connecting clip in accordance with the present invention of the above item (1), the open-operation obstructing means may have a set of engagement holes (15,16) which are provided in the upper end portions of the handling portions so as to face to each other, and an insertion device (17) inserted between the upper end portions of the handling portions, the insertion device comprising a plate portion (170), a fixed protrusion (171) formed so as to project from one end of the plate portion, a sliding protrusion (172) provided so as to project from or withdraw in the other end of the plate portion; and forcing means (177) for forcing the sliding protrusion in a direction such that the sliding protrusion is projected to the outside from the other end portion of the plate portion, the sliding protrusion and the fixed protrusion being respectively inserted into the engagement holes, and the sliding protrusion being locked in this state, for obstructing opening operation of the gripping portions.

the open-operation obstructing means may have a set of engagement holes which are provided in the upper end portions of the handling portions so as to face to each other; and an insertion device inserted between the upper end portions of the handling portions, and the insertion device may include a plate portion; a fixed protrusion formed so as to project from one end portion of the plate portion; a sliding protrusion provided so as to project from or withdraw in the other end of the plate portion; and forcing means for forcing the sliding protrusion in a direction such that the sliding protrusion is projected to the outside from the other end portion of the plate portion, and may be constructed so that, the sliding protrusion and the fixed protrusion being respectively inserted into the engagement holes, and the sliding protrusion being locked in this state.

In the joint connecting clip in accordance with the present invention of the above item (1), the open-operation obstructing means may have a set of locking convex portions (18,19) which are provided in the upper end portions of the handling portions and face to each other; and an insertion member (20) inserted between the upper end portions of the handling portions, and the insertion member may have a construction such that both ends of a plate spring material (200) are bent in the same direction, and both bent portions are provided with locking concave portions (202) which are concaved so as to match the shapes of the locking convex portions, and the locking concave portions are fitted on the locking convex portions by deflecting deformation of the bent portions, so that opening operation of the gripping portions is obstructed.

In the joint connecting clip in accordance with the present invention of the above item (2), a plurality of sprockets may be formed on the outer peripheral surfaces of the flange portions, and the engagement portion may have two opening holes (121,122) which is divided by a bridge (120), each of the opening holes engaging with a pair of sprockets (56A,64A) respectively formed on peripheries of the flange portions, and the bridge engaging with the concave portions (54B,64B) between the adjacent sprockets on the flange, for preventing joint relative turning.

In the joint connecting clip in accordance with the present invention of the above item (2), there may be provided a lock screw (217) for fixedly locking the joint connecting clip to the joint side.

To achieve the above object, (3) the present invention provides a joint connecting structure in which a first joint (50) having a flange portion (52) on the outer peripheral surface and a second joint (60) having a flange portion (62) on the outer peripheral surface are connected to each other so that the flange portions are butted against each other, wherein the joint connecting structure has a joint connecting clip (1) for fixing the flange portions in a state in which the flange portions are butted against each other, the joint connecting clip comprises: gripping portions (10) which are closed so as to hold the flange portions therebetween from outer periphery both sides; engagement portions (12) with which the outer peripheral portions of the flange portions engage, at least one of the engage portions having two opening holes (121,122) which is divided by a bar portion (120), each of the opening holes engaging with a pair of sprockets (56A, 64A) respectively formed on peripheries of the flange portions, and the bridge engaging with the concave portions (56B,64B) between the adjacent sprockets on the flange, for preventing joint relative turning; forcing means (5) for always forcing the gripping portions in the closing direction; and a pair of handling portions (11) which are integrally provided above the gripping portions, for opening the gripping portions apart from the flange portions by a pinching operation with access of only one direction from the upside of the gripping portions.

(4) The present invention also provides a joint connecting structure in which a first joint (50) having a flange portion (52) on the outer peripheral surface and a second joint (60) having a flange portion (62) on the outer peripheral surface are connected to each other so that the flange portions are butted against each other, wherein the joint connecting structure has a joint connecting clip ( 1) for fixing the flange portions in a state in which the flange portions are butted against each other, the joint connecting clip is formed by bending a plate (21) made of spring material, and comprises: gripping portions (10) which are closed so as to hold the flange portions therebetween from outer periphery both sides by elastic deformation of the plate spring material; an engagement portion (12) with which the outer peripheral portions of the flange portions engage when the gripping portions are closed; a pair of mounting holes (24,214,215) provided above the gripping portions; and a pair of handling members (22,23) which are insertedly mounted in the paired mounting holes detachably, for opening the gripping portions with access of only one direction from the upside of the gripping portions by a pinching operation.

In the joint connecting structure in accordance with the present invention of the above item (3), the joint connecting clip may further include open-operation obstructing means (14) for obstructing opening operation of the gripping portions.

In the joint connecting structure in accordance with the present invention of the above item (3), the open-operation obstructing means may have a set of engagement holes (15, 16) which are provided in the upper end portions of the handling portions so as to face to each other; and an insertion device (17) inserted between the upper end portions of the handling portions, and the insertion device may comprise a plate portion (170), a fixed protrusion (171) formed so as to project from one end of the plate portion, a sliding protrusion (172) provided so as to project from or withdraw in the other end of the plate portion; and forcing means (177) for forcing the sliding protrusion in a direction such that the sliding protrusion is projected to the outside from the other end of the plate portion, the sliding protrusion and the fixed protrusion being respectively inserted into the engagement holes, and the sliding protrusion being locked in this state, for obstructing opening operation of the gripping portions.

In the joint connecting structure in accordance with the present invention of the above item (3), the open-operation obstructing means may have a set of locking convex portions (18,19) which are provided in the upper end portions of the handling portions and face to each other; and an insertion member (20) inserted between the upper end portions of the handling portions, and the insertion member may have a construction such that both ends of a plate made of spring material are bent in the same direction, and both bent portions are provided with locking concave portions (202) which are concaved so as to match the shapes of the locking convex portions, and when opening operation of the gripping portions is obstructed, the locking concave portions are fitted on the locking convex portions by deflecting deformation of the bent portions.

In the joint connecting structure in accordance with the present invention of the above item (4), a plurality of sprockets (56,64) may be formed on the outer peripheral surfaces of the flange portions, and the engagement portion may have two opening holes (121,122) divided by a bridge (120), and may have a construction such that of the sprockets, at least any one of convex portions of the sprockets engages with one opening hole (121); an upper convex portion adjacent to the engaging convex portion engages with the other opening hole (122); and the bridge engages with the concave portion between the upper and lower convex portions engaging with the opening holes, by which the turning of the first and second joints is prevented.

In the joint connecting structure in accordance with the present invention of the above item (4), there may be provided a lock screw (217) for fixedly locking the joint connecting clip to the joint side.

In the present invention, there is adopted a configuration in which a paired handling portions (or members) are provided above the gripping portions, and the gripping portions are opened with access of only one direction by an operation of pinching the handling portions (or members) from upper both sides of the gripping portions. Therefore, the joint connecting clip can be removed easily with one hand only with access of one direction such that the paired handling members are pinched from the upside of the gripping portions.

Also, in the present invention, when it is attempted to remove the joint connecting clip, since the gripping portions are opened by a one-hand operation performed from the upside of the gripping portions, unlike the joint connecting clip having the conventional construction, there is no need for securing a space, which is necessary for removing the joint connecting clip, on both sides of the joint connecting clip. Since such a space can be omitted, a plurality of joint connecting clips can be arranged closely in the transverse direction in a row, so that the arrangement configuration of joint connecting clips can be simplified. Therefore, the joint connecting clip in accordance with the present invention is suitable for obtaining a compact piping configuration.

### BRIEF DESCRIPTION OF THE DRAWINGS

FIG. 1 is an explanatory view of a male joint (first joint), FIG. 1(A) being a front view of the male joint, FIG. 1(B) being a right side view thereof, and FIG. 1(C) being a sectional view taken along the line c-c of FIG. 1(A);

FIG. 2 is an explanatory view of a female joint (second joint) mating with the male joint shown in FIG. 1, FIG. 2(A) being a front view of the female joint, FIG. 2(B) being a right side view thereof, and FIG. 2(C) being a sectional view taken along the line c-c of FIG. 2(A);

FIG. 3 is an explanatory view showing a state in which the male joint shown in FIG. 1 and the female joint shown in FIG. 2 are connected to each other, FIG. 3 (A) being a front view of the connected male joint and female joint, and FIG. 3(B) being a sectional view taken along the line b-b of FIG. 3(A);

FIG. 4 is an explanatory view of a joint connecting clip in accordance with one embodiment of the present invention, FIG. 4(A) being a front view of the joint connecting clip, FIG. 4(B) being a top view thereof, and FIG. 4(C) being a right side view thereof;

FIG. 5 is an explanatory view of open-operation obstructing means which obstructs opening operation of gripping portions of the joint connecting clip shown in FIG. 4, FIG. 5(A) being a sectional view of the joint connecting clip and the open-operation obstructing means mounted thereto, which is viewed from the front, FIG. 5(B) being a top view thereof, and FIG. 5(C) being a right side view thereof;

FIG. 6 is an explanatory view showing a state in which the joint connecting clip shown in FIG. 4 is used and a state in which the open-operation obstructing means shown in FIG. 5 is used;

FIG. 7 is an explanatory view of a joint connecting clip in accordance with another embodiment of the present invention, FIG. 7(A) being a front view of the joint connecting clip, FIG. 7(B) being a top view thereof, and FIG. 7(C) being a right side view thereof;

FIG. 8 is an explanatory view of open-operation obstructing means which obstructs opening operation of gripping portions of the joint connecting clip shown in FIG. 7, FIG. 8(A) being a front view of the joint connecting clip and the open-operation obstructing means mounted thereto, FIG. 8(B) being a top view thereof, and FIG. 8(C) being a right side view thereof;

FIG. 9 is an explanatory view showing a state in which the joint connecting clip shown in FIG. 7 is used and a state in which the open-operation obstructing means shown in FIG. 8 is used;

FIG. 10 is an explanatory view of a joint connecting clip in accordance with still another embodiment of the present invention, FIG. 10(A) being a sectional view of the joint connecting clip, which is viewed from the front, FIG. 10(B) being a top view thereof, and FIG. 10(C) being a right side view thereof;

FIG. 11 is an explanatory view of open-operation obstructing means which obstructs opening operation of gripping portions of the joint connecting clip shown in FIG. 10;

FIG. 12 is an explanatory view showing a state in which the joint connecting clip shown in FIG. 10 is used and a state in which the open-operation obstructing means shown in FIG. 11 is used;

FIG. 13 is an explanatory view of a joint connecting clip in accordance with still another embodiment of the present invention, FIG. 13(A) being a sectional view of the joint connecting clip, which is viewed from the front, FIG. 13(B) being a top view thereof, and FIG. 13(C) being a right side view thereof; and

FIG. 14 is an explanatory view showing a state in which the joint connecting clip shown in FIG. 13 is used.

### DETAILED DESCRIPTION OF THE PREFERRED EMBODIMENTS

Preferred embodiments of the present invention will now be described in detail with reference to the accompanying drawings.

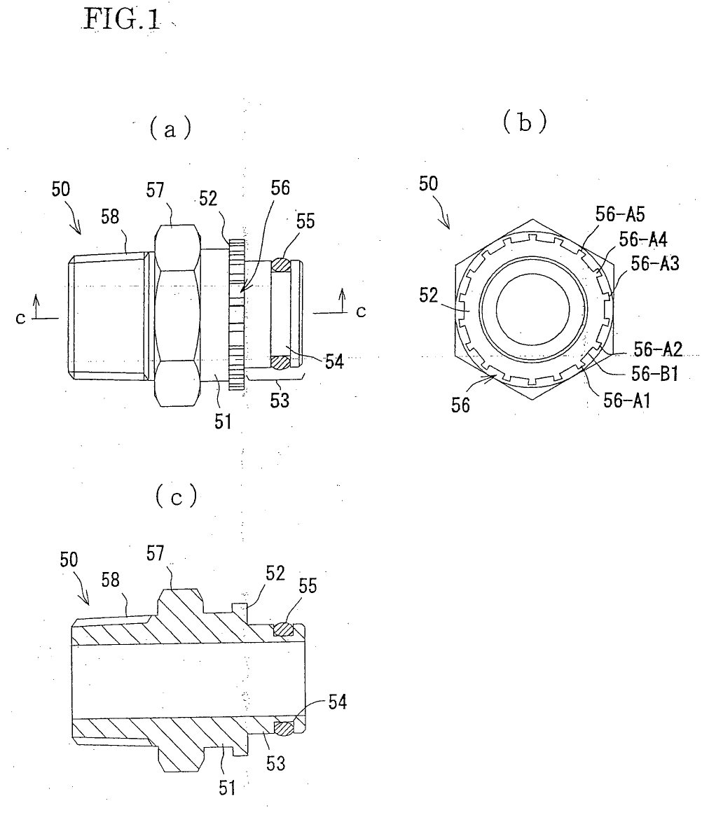

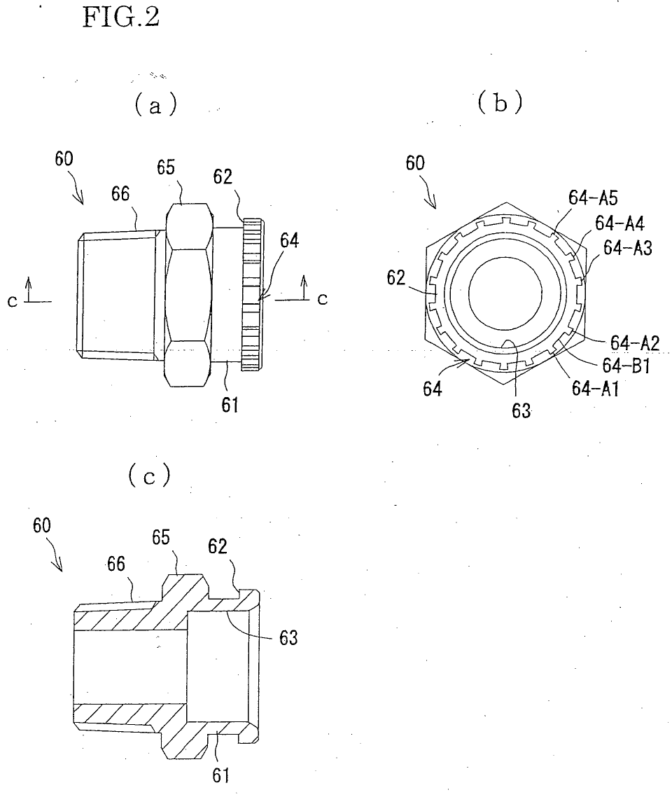

FIG. 1 is an explanatory view of a male joint (first joint). A male joint 50 shown in FIG. 1 has a construction such that a flange portion 52 is integrally formed on the outer peripheral surface of a cylindrical body 51. The flange portion 52 is formed at a position slightly retracting from the tip end (one end) of the body 51. Also, a tip end portion of the body 51 in front of the flange portion 52 is formed as an insertion portion 53 that is inserted into a female joint 60 shown in FIG. 2, and on the outer peripheral surface of the insertion portion 53, a no-ring mounting groove 54 and an O-ring 55 mounted irregin the groove 54 are provided. Further, on the outer peripheral surface of the flange portion 52, ularities 56 are formed at fixed intervals.

FIG. 2 is an explanatory view of a female joint (second joint) mating with the male joint shown in FIG. 1. A female joint 60 shown in FIG. 2 has a construction such that a flange portion 62 is integrally formed on the outer peripheral surface of a cylindrical body 61. In the female joint 60 shown in FIG. 2, the flange portion 62 has the same diameter as that of the flange portion 52 of the male joint 50, and is formed at the tip end (one end) of the body 61. An inside space on the tip end portion side of the body 61 forms an insertion hole 63 into which the insertion portion 53 of the male joint 50 is inserted. On the outer peripheral surface of the flange portion 62 of the female joint 60 as well, sprockets 64 similar to those on the flange portion 52 are formed at the same fixed intervals as those of the sprockets 56 of the male joint 50.

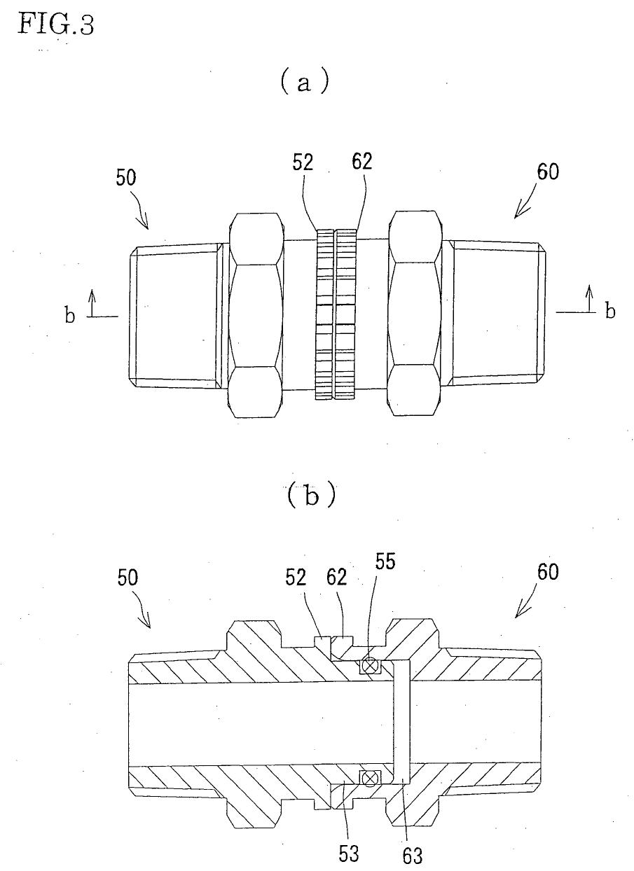

When the insertion portion 53 of the male joint 50 is inserted into the insertion hole 63 of the female joint 60, as shown in FIG. 3, the male joint 50 and the female joint 60 are connected to each other in a state in which the flange portions 52 and 62 are butted against each other.

In this embodiment, it is assumed that the male joint 50 and the female joint 60 are directly attached to equipment that handles a fluid, such as a flow control valve, or a hose (pipe). In order to install the male joint 50 to the equipment, an externally threaded portion 58 formed on the rear end outer peripheral surface of the body 51 or a connecting portion such as a flange is connected to a connecting portion of the equipment or the hose (pipe). This work is performed by gripping a nut 57 provided integrally on the body middle portion outer peripheral surface of the body 51. Also, in order to install the female joint 60 to the equipment, an externally threaded portion 66 formed on the rear end outer peripheral surface of the body 61 is screwed in the joint connecting portion of the equipment. This work is performed by gripping a nut 65 provided integrally on the body middle portion outer peripheral surface of the body 61.

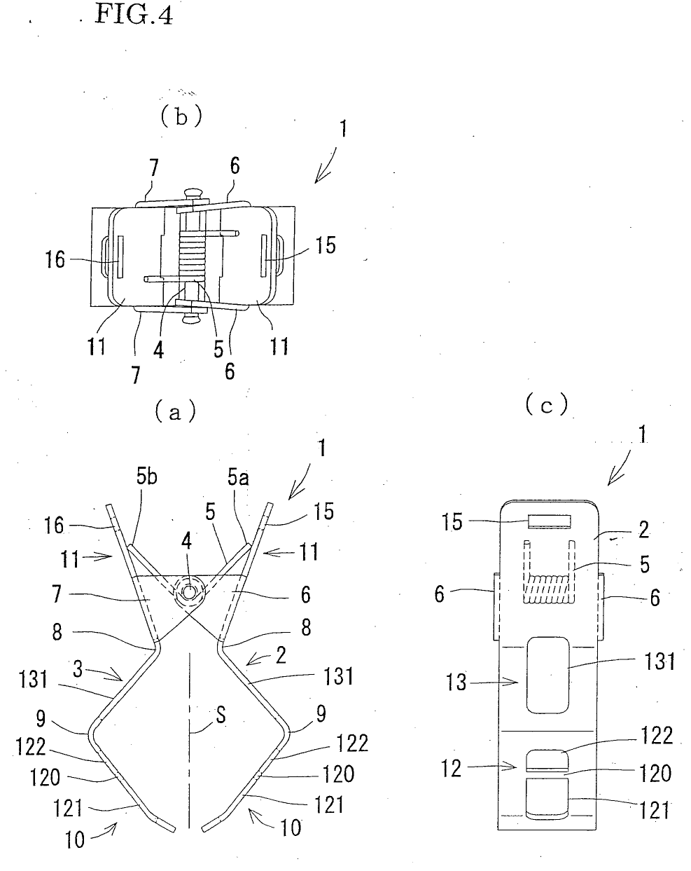

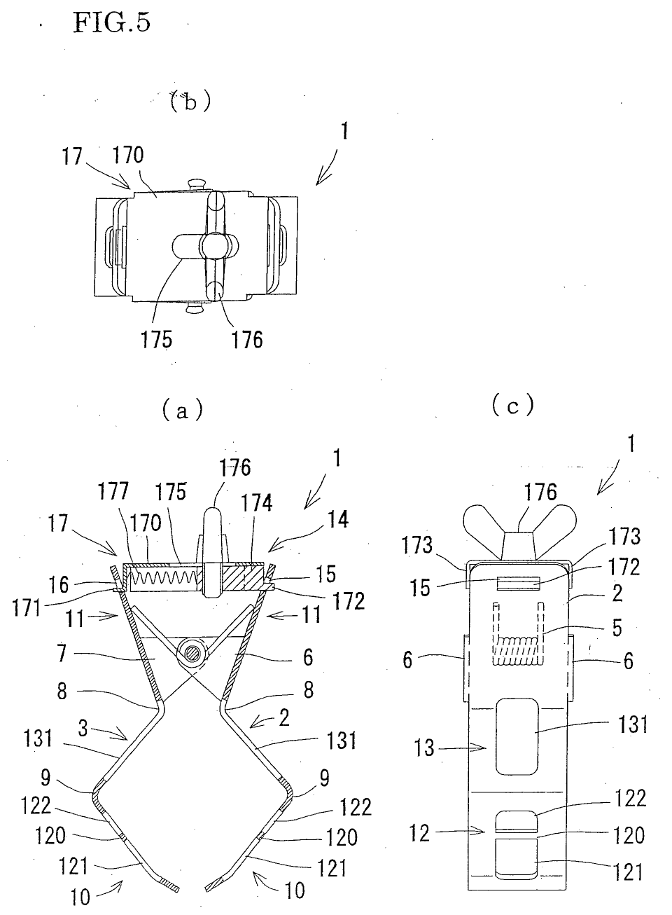

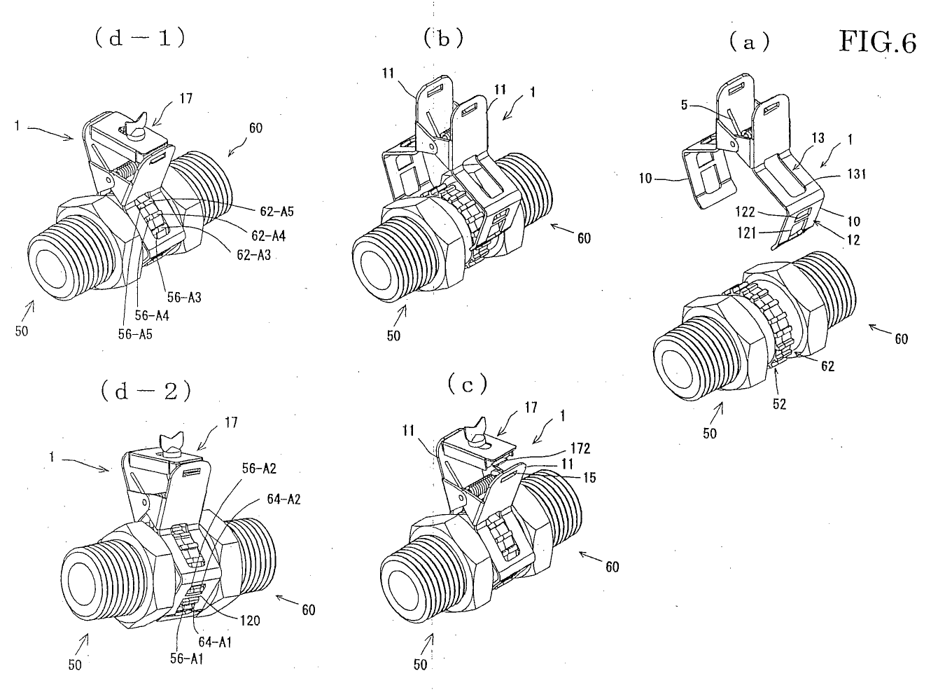

FIG. 4 is an explanatory view of a joint connecting clip in accordance with one embodiment of the present invention, FIG. 5 is an explanatory view of open-operation obstructing means which obstructs opening operation of gripping portions of the joint connecting clip shown in FIG. 4, and FIG. 6 is an explanatory view showing a state in which the joint connecting clip shown in FIG. 4 is used and a state in which the open-operation obstructing means shown in FIG. 5 is used.

A joint connecting clip 1 shown in FIG. 4 is used as a means for preventing the male joint 50 and the female joint 60 from coming off by fixing the male joint 50 and the female joint 60 connected as shown in FIG. 3 to each other in a state in which the flange portions 52 and 62 are butted against each other (refer to FIG. 6).

The joint connecting clip 1 shown in FIG. 4 is made up of two metal plate members 2 and 3, a pin shaft 4, and a spring 5. The two metal plate members 2 and 3 face to each other via the pin shaft 4, and are arranged so as to be at right angles to the pin shaft 4.

Also, the metal plate members 2 and 3 are provided so as to be turnable around the pin shaft 4. As a turnable configuration of the metal plate members 2 and 3, in this embodiment, bent elements 6 and 7, which are bent substantially at right angles and projected toward the pin shaft, are provided at both side edges of the metal plate members 2 and 3, the bent element 6 of one metal plate member 2 and the bent element 7 of the other metal plate member 3 are overlapped, and the pin shaft 4 penetrates the overlapping portion.

Further, each of the metal plate members 2 and 3 is formed with a valley bent portion 8 and a peak bent portion 9 viewed from the centerline S of the joint connecting clip 1. The valley bent portion 8 is provided below the bent element 6, 7 of the metal plate member 2, 3, and on the other hand, the peak bent portion 9 is provided below the valley bent portion 8.

In this embodiment, of the whole of the metal plate members 2 and 3, peripheral portions on both sides of the peak bent portions 9 serve as a portion for closing so as to hold the flange portions 52 and 62 of the male joint 50 and the female joint 60 therebetween from the outer periphery both sides as gripping portions 10 of the joint connecting clip 1. Also, of the whole of the metal plate members 2 and 3, portions above the valley bent portions 8, namely, portions that are open into a V shape with respect to the centerline S of the joint connecting clip 1 serves as a portion operated so as to be pinched from upper both sides of the gripping portion 10 as a pair of handling portions 11 of the joint connecting clip 1.

The aforementioned gripping portions 10 of the joint connecting clip 1 are always forced in the closing direction by the force of the spring 5.

Specifically, the spring 5 is mounted on the pin shaft 4. One end (right end) 5a of the spring 5 is configured so as to press an upper portion of the metal plate member 2 on the right-hand side in the figure from the inside to the outside, and the other end (left end) 5b of the spring 5 is configured so as to press an upper portion of the metal plate member 3 on the left-hand side in the figure from the inside to the outside.

By the action of force of the spring 5, a clockwise turning force around the pin shaft 4 is given to the upper side of the right-hand side metal plate member 2, namely, one handling portion 11, and a counterclockwise turning force around the pin shaft 4 is given to the upper side of the left-hand side metal plate member 3, namely, the other handling portion 11. Therefore, the two metal plate members 2 and 3 are in a state of being closed so that the lower sides thereof collide opposedly. This state is a closing state of the gripping portions 10 of the joint connecting clip 1. For convenience of explanation, a state in which the gripping portions 10 are slightly open is shown in FIGS. 4, 5, 7 and 8.

When the paired handling portions 11 are operated so as to be pinched with a force greater than the force of the spring 5, the right-hand side metal plate member 2 turns counterclockwise around the pin shaft 4, and at the same time, the left-hand side metal plate member 3 turns clockwise around the pin shaft 4, by which the gripping portion 10 having been closed by the force of the spring 5 is opened.

The gripping portion 10 of the joint connecting clip 1 constructed as described above is provided with a first engagement portion 12 and a second engagement portion 13 as portions with which the outer peripheral portions of flange portions of the male joint 50 and the female joint 60 engage.

The first and second engagement portions 12 and 13 are configured so as to be arranged vertically along the outer peripheries of the flange portions 52 and 62 of the male and female joints 50 and 60. Also, of the engagement portions 12 and 13, the lower first engagement portion 12 is formed by two opening holes 121 and 122 divided vertically by a bridge 120.

This embodiment employs a construction such that of the sprockets 56 and 64 on the outer peripheral surfaces of the flange portions 52 and 62 of the male and female joints 50 and 60, at least any one of convex portions 56-A1 engages with one (lower) opening hole 121, an upper convex portion 56-A2 adjacent to the engaging convex portion 56-A1 engages with the other (upper) opening hole 122, and further the bridge 120 engages with the concave portion 56-B1, 64-B1 between the upper and lower convex portions 56-A2 and 56-A1 engaging with the opening holes 121 and 122, by which the turning of the male and female joints 50 and 60 is prevented (refer to FIG. 6(D-2)). On the other hand, the upper second engagement portion 13 consists of one opening hole 131 so that other several number of convex portions 56-A3, 56-A4 and 56-A5 engage with the opening hole 131 (refer to FIG. 6(D-1)).

The joint connecting clip 1 shown in FIG. 4 is provided with open-operation obstructing means 14 for obstructing/locking an operation for opening the gripping portions 10. The open-operation obstructing means 14 is made up of a set of engagement holes 15 and 16 and an insertion device (slide lock device) 17. The set of the engagement holes 15 and 16 are formed in upper end portions of the handling portions 11 of the joint connecting clip 1, namely, in upper end portions of the metal plate members 2 and 3, respectively, so as to face to each other. The insertion device 17 is inserted between the upper end portions of the handling portions 11 of the joint connecting clip 1, namely, between the upper end portions of the metal plate members 2 and 3. The insertion device 17 is specifically configured as described below.

The insertion device 17 has a metallic plate portion 170. In one end portion of the plate portion 170, a fixed protrusion 171 is projectingly formed, and in the other end portion of the plate portion 170, a sliding protrusion. 172 is provided. The fixed protrusion 171 has a construction formed by bending one end portion of the plate portion 170, and is integrally fixed to the plate portion 170. On the other hand, the sliding protrusion 172 is provided so as to project from or withdraw in the other end portion of the plate portion 170.

As a specific configuration for providing the sliding protrusion 172 so as to project from or withdraw in the other end portion of the plate portion 170 as described above, a configuration was adopted in which slide guide plates 173 are provided at both side edges of the plate portion 170, a slider 174 is arranged between the slide guide plates 173, and the sliding protrusion 172 is integrally formed in the tip end portion in the slide direction of the slider 174.

In this configuration, the slider 174 is supported on the plate portion 170 side by a screw 176 inserted in an elongated hole 175 provided in the plate portion 170. When the screw 176 is tightened, the slider 174 comes into close contact with the plate portion 170, by which the slider 174 is made incapable of sliding. When the screw 176 is loosened, the contacting state of the slider 174 and the plate portion 170 is released, so that the slider 174 becomes slidable while being guided by the slide guide plates 173 with a stroke corresponding to the length of the elongated hole 175. Also, the slider 174 is always forced by a spring 177 in the direction such that the sliding protrusion 172 is projected to the outside.

In order to obstruct opening operation of the gripping portions 10 of the joint connecting clip 1 by using the insertion device (slide lock device) 17 having the above-described construction, the screw 176 is loosened to make the slider 174 capable of sliding, and thereby the sliding protrusion 172 is retracted (refer to FIG. 6(C)). In this state, the whole of the insertion device 17 is inserted between the upper end portions of the handling portions 11 of the joint connecting clip 1. At this time, the fixed protrusion 171 is inserted in one engagement hole 16, and the sliding protrusion 172 is arranged so as to face to the other engagement hole 15. Then, the sliding protrusion 172 is projected by the force of the spring 177. The projecting sliding protrusion 172 engages with the other engagement hole 15, and in this state, the screw 176 is tightened. Thus, the slider 174 becomes incapable of sliding, and hence the sliding protrusion 172 is locked. After the work for setting the insertion device 17 has been finished in this manner, the whole of the insertion device 17 becomes an obstacle to an operation for pinching the handling portions 11 of the joint connecting clip 1. Therefore, that operation cannot be performed, so that the operation for opening the gripping portions 10 of the joint connecting clip 1 is obstructed.

A usage example of the joint connecting clip 1 constructed as described above, which is shown in FIG. 4, will be explained with reference to FIG. 6.

A work procedure for fixing the male joint 50 and the female joint 60 to each other by using the joint connecting clip 1 shown in FIG. 4 is as described below. First, the male joint 50 and the female joint 60 are connected to each other as shown in FIG. 6(A). On the other hand, the paired handling portions 11 are pinched with one hand from the upside of the gripping portions 10 of the joint connecting clip 1 shown in FIG. 4 so that the handling portions 11 are brought close to each other, by which the gripping portions 10 are opened as shown in FIG. 6(A) with access of only one direction from the upside of the gripping portions 10. In this state, as shown in FIG. 6(B), the open gripping portions 10 are set so as to cover the outer peripheral portions of the flange portions 52 and 62 of the male and female joints 50 and 60, and the hand that pinches the handling portions 11 is let go.

Thereby, the gripping portions 10 are closed by the force of the spring 5, so that the outer peripheral portions of the flange portions 52 and 62 engage with the engagement portions 12 and 13 of the gripping portions 10. This engaging mode is a mode in which as shown in FIGS. 6(C), 6(D-1) and 6(D-2), the convex portions 56-A1 and 64-A1 on the outer peripheral surfaces of the flanges 52 and 62 engage with the opening hole 121, the upper convex portions 56-A2 and 64-A2 adjacent to the engaging convex portions 56-A1 and 64-A1 engage with the opening hole 122, and further the bridge 120 engages with the concave portions 56-B1 and 64-B1 between the upper and lower convex portions 56-A2 and 56-A1 and 64-A2 and 64-A1 engaging with the opening holes 121 and 122, and a mode in which the plurality of convex portions 56-A3, 56-A4, 56-A5, 64-A3, 64-A4 and 64-A5 engage with the opening hole 131. Also, the engaging mode is a loosely engaging mode in which a gap is provided in the vertical direction of the convex portions 56-A1, 64-A1, 56-A2 and 64-A2. The reason for this is as follows: for example, the convex portion 56-A1 of the male joint 50 and the convex portion 64-A1 of the female joint 60 do not sometimes align with each other in a straight line depending on the installation state of the male joint 50 and the female joint 60 to the equipment, and even if such a shift occurs, both of the convex portions 56-A1 and 64-A1 are made capable of engaging with one opening hole 121.

By the above-described procedure, the fixing of the male joint 50 and the female joint 60 using the joint connecting clip 1 is competed. In order to remove the joint connecting clip 1 that fixes the male joint 50 and the female joint 60 to each other, the paired handling portions 11 have only to be pinched with one hand from upper both sides of the gripping portions 10 of the joint connecting clip 1 so that the handling portions 11 are brought close to each other. By doing this, the gripping portions 10 are opened with access of only one direction from the upside of the gripping portions 10. Thereby, the engagement portions 12 and 13 are removed from the flange portions 52 and 62, so that the joint connecting clip 1 can be removed easily.

In the case where it is desired to obstruct the operation for opening the gripping portions 10 of the joint connecting clip 1 that fixes the male joint 50 and the female joint 60 to each other as described above, work for setting the insertion device 17 on the handling portion 11 side of the joint connecting clip 1 is performed. This setting work is performed in accordance with the following steps:

<Step 1>

First, as shown in FIG. 6(C), the sliding protrusion 172 is retracted, and in this state, the whole of the insertion device 17 is inserted between the upper end portions of the handling portions 11 of the joint connecting clip 1. In order to retract the sliding protrusion 172, the screw 176 has only to be loosened to slide the slider 174. When the insertion device 17 is inserted, the fixed protrusion 171 of the insertion device 17 is inserted into one engagement hole 16, and the sliding protrusion 172 is arranged so as to face to the other engagement hole 15. As shown in FIGS. 6(D-1) and 6(D-2), the projecting sliding protrusion 172 is allowed to engage with the other engagement hole 15 by the force of the spring 177.

<Step 2>

Next, the screw 176 is tightened not to allow the slider 174 to slide, locking the sliding protrusion 172. Thereby, the fixed protrusion 171 and the sliding protrusion 172 are engaged with the engagement holes 15 and 16, respectively, so that the insertion device 17 is prevented from coming off between the upper end portions of the handling portions 11. Also, the insertion device 17 disables the operation for pinching the handling portions 11, so that the operation for opening the gripping portions 10 of the joint connecting clip 1 by the pinching operation is obstructed. By performing the above steps, the work for setting the insertion device 17 is completed.

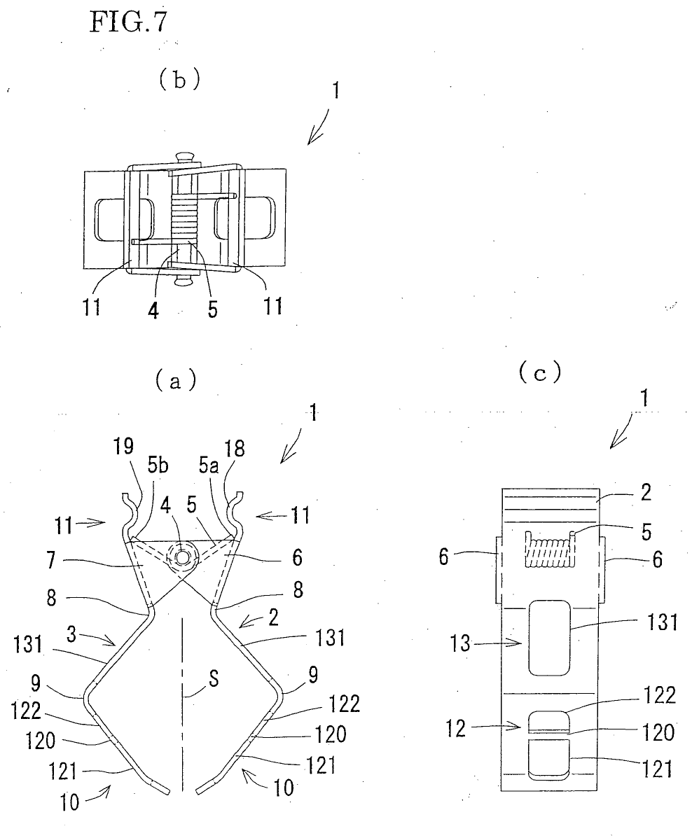

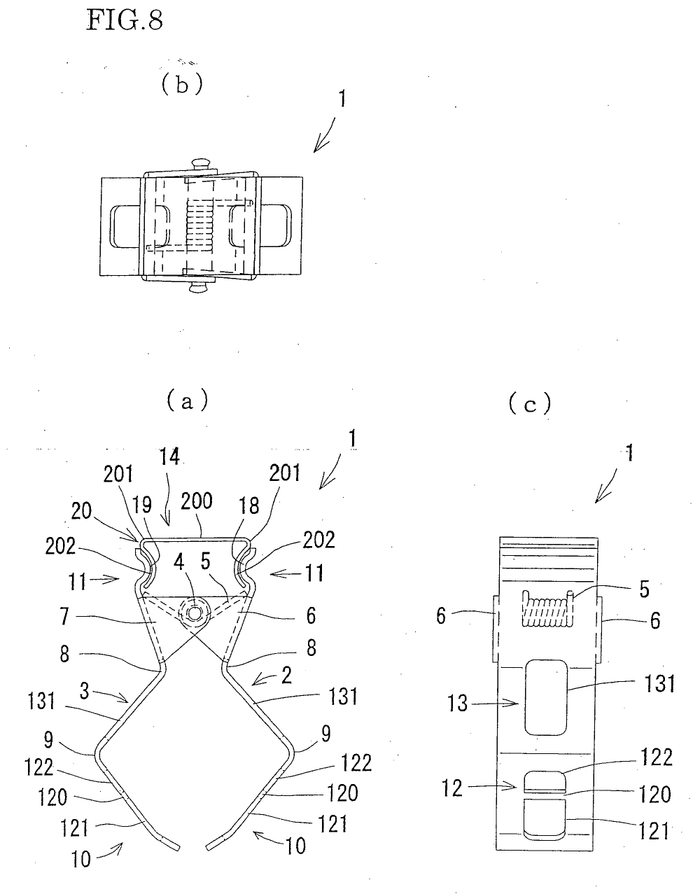

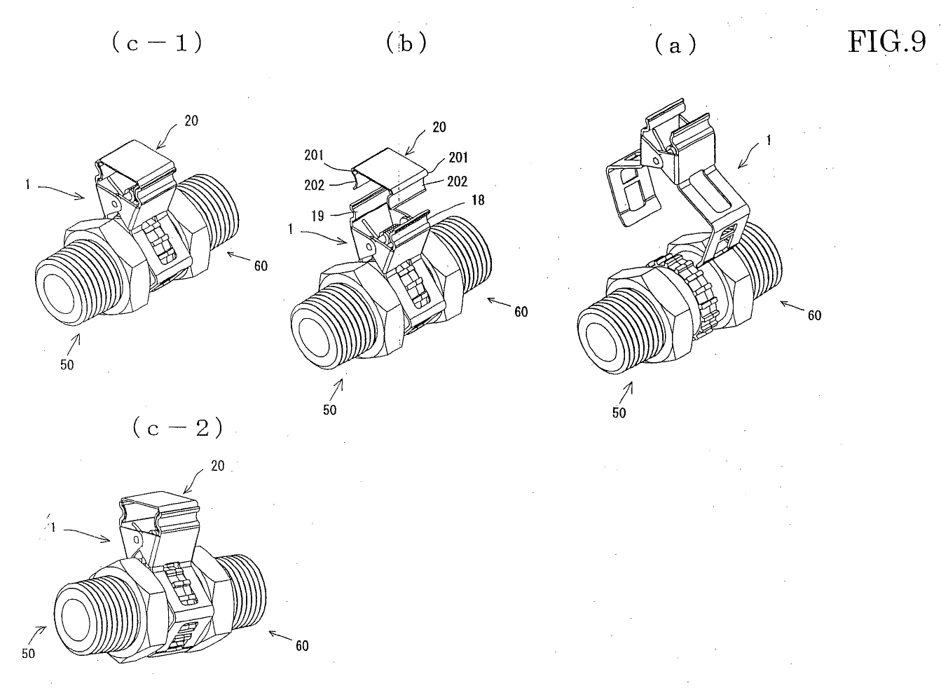

FIG. 7 is an explanatory view of a joint connecting clip in accordance with another embodiment of the present invention, FIG. 8 is an explanatory view of open-operation obstructing means which obstructs opening operation of gripping portions of the joint connecting clip shown in FIG. 7, and FIG. 9 is an explanatory view showing a state in which the joint connecting clip shown in FIG. 7 is used and a state in which the open-operation obstructing means shown in FIG. 8 is used.

The basic construction of the joint connecting clip shown in FIG. 7 is the same as that of the joint connecting clip shown in FIG. 4. Therefore, the same reference numerals are applied to elements that are the same as those in FIG. 4, and the detailed explanation thereof is omitted. The joint connecting clip shown in FIG. 7 has open-operation obstructing means 14 of a construction different from that for the joint connecting clip shown in FIG. 4.

Specifically, the open-operation obstructing means 14 for the joint connecting clip shown in FIG. 7 is made up of a set of locking convex portions 18 and 19 and an insertion member (one-touch lock member) 20 of a construction different from that shown in FIG. 5. Like the set of engagement holes 15 and 16 shown in FIG. 5, the set of locking convex portions 18 and 19 are provided in the upper end portions of the handling portions 11 of the joint connecting clip 1, namely, in the upper end portions of the metal plate members 2 and 3 so as to face to each other. The insertion member 20 has a construction such that both ends of a plate spring material 200 are bent in the same direction, and both bent portions 201 are provided with locking concave portions 202 that are concaved so as to match the shapes of the locking convex portions 18 and 19. Like the insertion device 17 shown in FIG. 5, this insertion member 20 is also inserted between the upper end portions of the handling portions 11.

In order to obstruct opening operation of the gripping portions of the joint connecting clip i by using the insertion member (one-touch lock member) 20 having the above-described construction, as shown in FIG. 9(B), the insertion member 20 is put on the upper end portions of the handling portions 11 with the bent portions 201 being directed downward, and in this state, the top surface of the insertion member 20 is pressed by a finger from the upside. By doing this, as shown in FIGS. 9(C-1) and 9(C-2), the locking concave portions 202 are fitted on the locking convex portions 18 and 19 by deflecting deformation of the bent portions 201. After the one-touch setting operation of merely pressing the insertion member 20 has been completed in this manner, the whole of the insertion member 20 becomes an obstacle to the operation for pinching the handling portions 11 of the joint connecting clip 1, so that the operation cannot be performed. Therefore, the operation for opening the gripping portions 10 of the joint connecting clip 1 is obstructed.

The work procedure for fixing the male joint 50 and the female joint 60 to each other by using the joint connecting clip 1 shown in FIG. 7 is the same as that for the joint connecting clip 1 shown in FIG. 4 (refer to FIGS. 6(A), 6(B) and 6(C)) as shown in FIGS. 9(A) and 9(B)), so that the detailed explanation thereof is omitted.

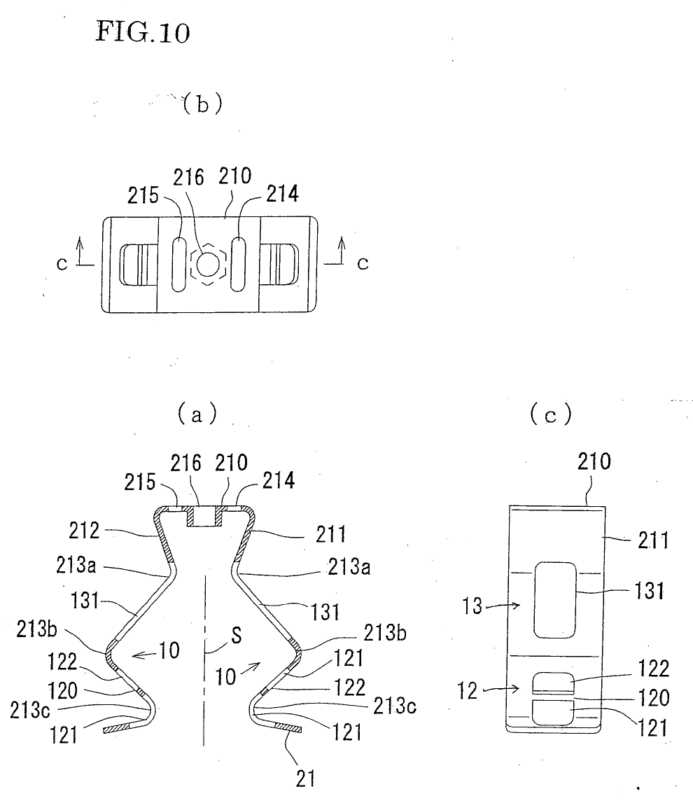

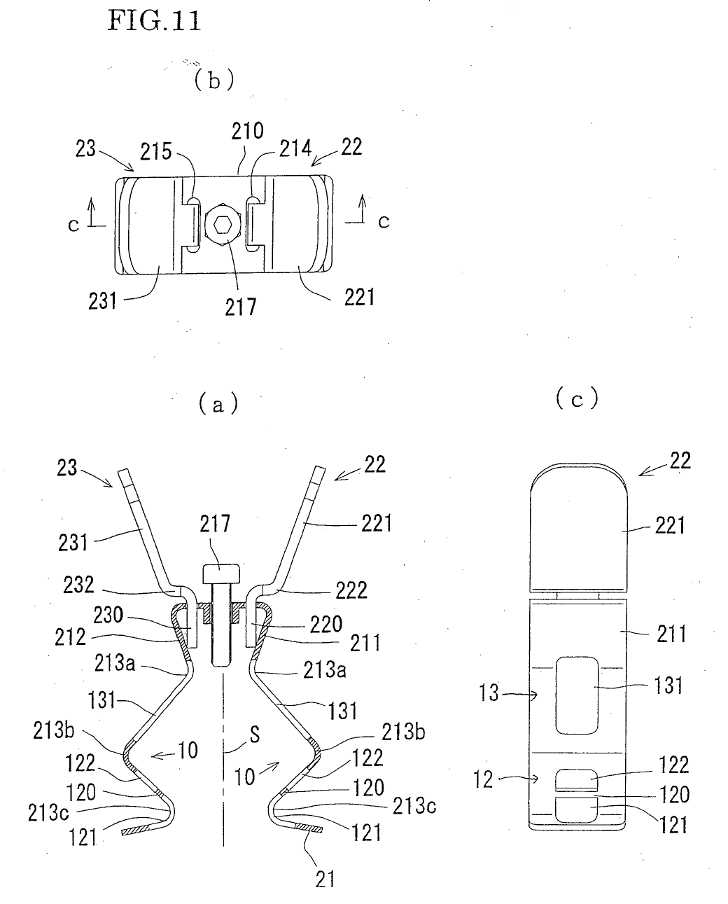

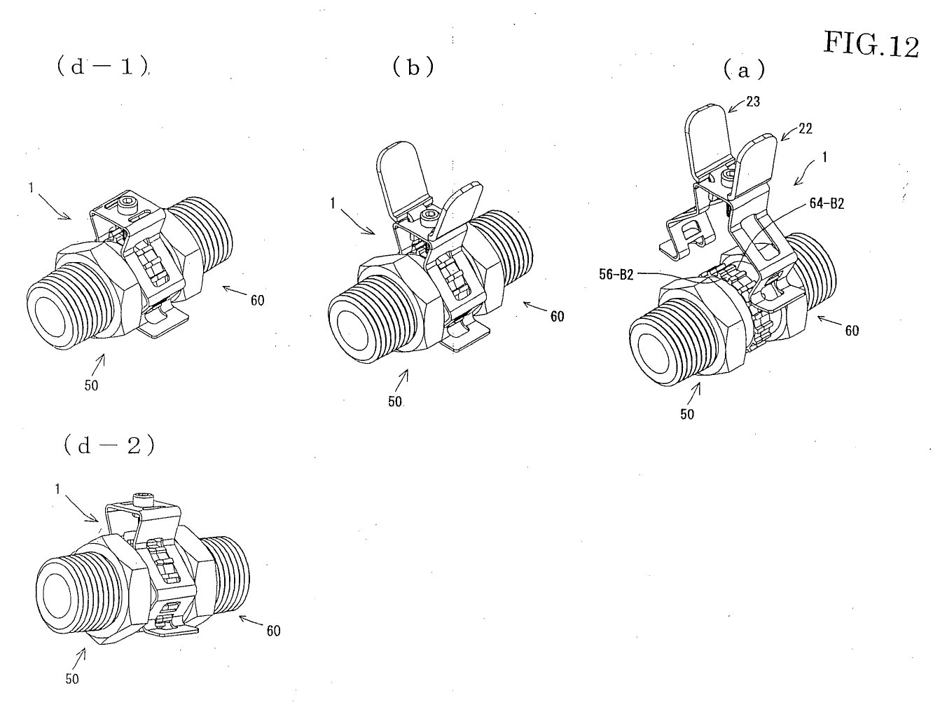

FIG. 10 is an explanatory view of a joint connecting clip in accordance with still another embodiment of the present invention, FIG. 11 is an explanatory view of open-operation obstructing means which obstructs opening operation of gripping portions of the joint connecting clip shown in FIG. 10, and FIG. 12 is an explanatory view showing a state in which the joint connecting clip shown in FIG. 10 is used and a state in which the open-operation obstructing means shown in FIG. 11 is used.

For the male joint 50 and the female joint 60 connected as shown in FIG. 3, the joint connecting clip shown in FIG. 10 is used as a means for preventing the male joint 50 and the female joint 60 from coming off each other by fixing the flange portions 52 and 62 to each other in a butted state (refer to FIG. 12).

The joint connecting clip 1 shown in FIG. 10 consists of one plate spring material 21 that is bendedly formed. In this embodiment, as a specific construction of the joint connecting clip 1, one plate spring material 21 is bent in the same direction at two places near the central portion, by which a top plate portion 210 and right and left inclined plate portions 211 and 212, which are inclined so as to become narrower on the lower side, are formed. Also, the inclined plate portions 211 and 212 are further bent at three places. Of bent portions 213A, 213B and 213C at three places, the first bent portion 213A close to the upper portion of the clip 1 is valley bent as viewed from the centerline S of the joint connecting clip 1. The second bent portion 213B, which is located below the first bent portion 213A, is peak bent as viewed from the centerline S of the joint connecting clip 1. Further, the third bent portion 213C, which is located below the second bent portion 213B, is valley bent as viewed from the centerline S of the joint connecting clip 1. A tip end portion from the third bent portion 213C is parallel with the top plate portion 210 in the upper portion of the clip 1. Further, the top plate portion 210 is provided with a threaded hole 216 so that a lock screw 217 can be installed in the downward direction in this threaded hole 216.

Of the one plate spring material 21 bent as described above, a range running from the first bent portion 213A to the third bent portion 213C through the second bent portion 213B forms the gripping portion 10 of the joint connecting clip 1 shown in FIG. 10. The gripping portions 10 can be opened and closed transversely with both sides of the top plate portion 210 being supporting points by elastic deformation of the plate spring material 21, and are closed so as to hold the outer peripheries of the flange portions 52 and 62 of the male joint 50 and the female joint 60 therebetween from both sides.

The gripping portion 10 of the joint connecting clip 1 shown in FIG. 10 is also provided with the engagement portions 12 and 13. The specific construction of the engagement portions 12 and 13 are the same as that shown in FIG. 4, so that the same reference numerals are applied to elements that are the same as those shown in FIG. 4, and the detailed explanation thereof is omitted.

In the joint connecting clip 1 shown in FIG. 10, the upper portion of the gripping portion 10, specifically, the top plate portion 210 is provided with a pair of mounting holes 214 and 215. One mounting hole 214 is provided so as to be close to one inclined plate portion 211, and the other mounting hole 215 is provided so as to be close to the other inclined plate portion 212.

Also, the joint connecting clip 1 shown in FIG. 10 is provided with a pair of handling members 22 and 23 (refer to FIG. 11). One handling element 22 includes a pressing plate portion 220, which is detachably inserted in the mounting hole 214 in the joint connecting clip 1, and a pinching plate portion 221, which is bent into an S shape from the upper end of the pressing plate portion 220 and is inclined slantwise upward. The other handling members 23 also includes a pressing plate portion 230 and a pinching plate portion 231 in the same way.

The paired handling members 22 and 23 having the above-described construction are used when the gripping portions 10 of the joint connecting clip 1 are opened. In order to open the gripping portions 10, the pressing plate portions 220 and 230 of the handling members 22 and 23 are inserted into the corresponding mounting holes 214 and 215 substantially at right angles from above the top plate portion 210. By doing this, the tip ends of the pressing plate portions 220 and 230 of the handling members 22 and 23 are brought into contact with the corresponding inclined plate portions 211 and 212. Also, the pinching plate portions 221 and 231 of the handling members 22 and 23 are arranged in a state of being open in a V shape toward the outside. In this state, when the pinching plate portions 221 and 231 of the handling members 22 and 23 are pinched from upper both sides of the gripping portions 10 so as to be brought close to each other, the pressing plate portions 220 and 230 of the handling members 22 and 23 press the inclined plate portions 211 and 212 to the outside using the principle of the lever with the S-shaped portions 222 and 232 of the handling members 22 and 23 being the fulcrums, by which the gripping portions 10 are opened.

A usage example of the joint connecting clip 1 constructed as described above, which is shown in FIG. 10, will be explained with reference to FIG. 12.

A work procedure for fixing the male joint 50 and the female joint 60 to each other by using the joint connecting clip 1 shown in FIG. 10 is as described below. As shown in FIG. 12(A), the paired handling members 22 and 23 are insertedly set in the mounting holes 214 and 215 in the joint connecting clip 1. Then, the handling members 22 and 23 are pinched with one hand from upper both sides of the gripping portions 10 so as to be brought close to each other. Thereby, the gripping portions 10 are opened as shown in FIG. 12(A) with access of only one direction from the upside of the gripping portions 10. In this state, as shown in FIG. 12(B), the open gripping portions 10 are set so as to cover the outer peripheral portions of the flange portions 52 and 62 of the male and female joints 50 and 60, and the hand that pinches the handling members 22 and 23 is let go.

By doing this, the gripping portions 10 are closed by the spring force of the plate spring material 21, and the outer peripheral portions of the flange portions 52 and 62 engage with the engagement portions 12 and 13 of the gripping portions 10. This engaging mode is the same as that for the joint connecting clip 1 shown in FIG. 4. When the lock screw 217 of the top plate portion 210 is tightened in this engaged state, the tip end of the lock screw 217 presses the bottoms of the concave portions 56-B2 and 64-B2 of the flange portions 52 and 62, and the whole of the joint connecting clip 1 is pulled upward by the reaction. Thereby, the bridge 120 of the first engagement portion 12 is strongly brought into contact with the convex portions 56-A2 and 64-A2 of the flange portions 52 and 62 located above the bridge 120, so that the connection fixing force of the male and female joints 50 and 60 due to the joint connecting clip 1 increases. Therefore, the joint connecting clip 1 is fixedly locked to the male and female joint 50 and 60 side, and the male and female joints 50 and 60 are firmly fixed via the joint connecting clip 1.

By the above-described procedure, the fixing of the male joint 50 and the female joint 60 using the joint connecting clip 1 shown in FIG. 10 is completed. After the fixing has been completed, the paired handling members 22 and 23 are removed, and are stored at a predetermined place.

In order to remove the joint connecting clip 1 shown in FIG. 10 that fixes the male joint 50 and the female joint 60 to each other as described above, as in the case of the installation, the paired handling members 22 and 23 are insertedly set in the mounting holes 214 and 215 in the joint connecting clip 1. Then, the paired handling members 22 and 23 have only to be pinched with one hand from upper both sides of the gripping portions 10 so as to be brought close to each other. By doing this, the gripping portions 10 are opened, and thereby the engagement portions 12 and 13 are removed from the flange portions 52 and 62, so that the joint connecting clip 1 shown in FIG. 10 can be removed easily.

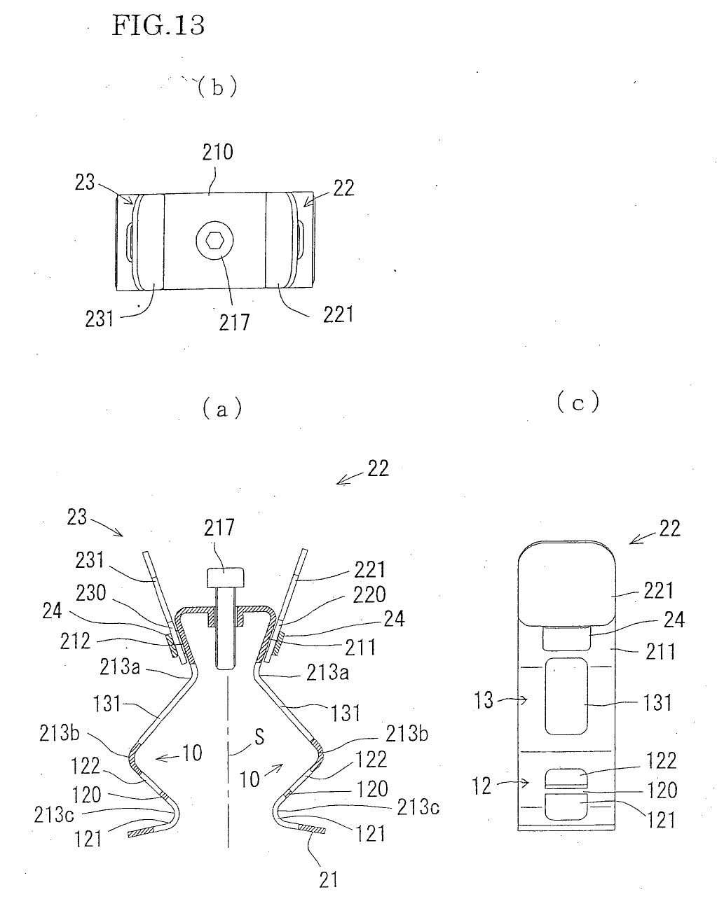

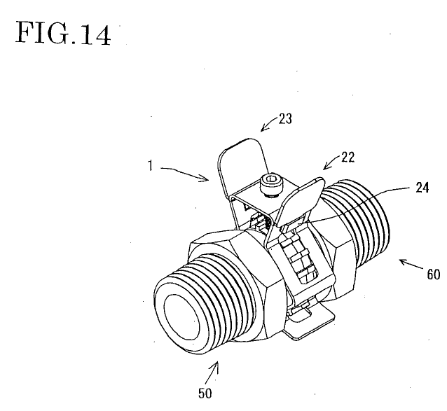

The joint connecting clip 1 shown in FIG. 10 employs a construction in which paired mounting holes 214 and 215 are provided in the top plate portion 210, and the paired handling members 22 and 23 are insertedly mounted in the mounting holes 214 and 215. However, in place of this construction, as in the case of the joint connecting clip 1 shown in FIG. 13, a construction can be employed in which pockets 24 that are open upward and downward are integrally provided on the inclined plate portions 211 and 212 (refer to FIG. 14), and the handling members 22 and 23 are insertedly mounted in the pockets 24. In this case, the inside portions of the pockets 24 function as mounting holes for the handling members 22 and 23. Also, the handling members 22 and 23 insertedly mounted in the pockets 24 have a flat plate construction that is not bent as shown in FIG. 13. By employing such a construction, the cost of the whole of the clip 1 can be reduced due to the saving of the bending fabrication cost.

What is claimed is:

1. A joint connecting clip for connecting a pair of joints (50,60) which are arranged to butt against each other at a flange portion (52,62) of the joints, holding the butted flange portions therein, comprising:
gripping portions (10) arranged to surround and hold the flange portions of the joints therebetween;
engagement portions (12,13) to engage with the outer peripheries of the flange portions when the gripping portions surround and hold the flange portions, at least one of the engage portions having two opening holes (121,122) which is divided by a bridge (120), each of the opening holes engaging with a pair of sprockets (56A,64A) respectively formed on peripheries of the flange portions, and the bridge engaging with the concave portions (56B,64B) between the adjacent sprockets on the flange, for preventing joint relative turning;
forcing means (5) for always forcing the gripping portions in the holding direction; and
a pair of handling portions (11) integrally formed with the gripping portions, for opening the gripping portions against the force of the forcing means apart from the flange portions, by a pinching operation thereon with only-one-direction access from the upside of the gripping portions.

2. A joint connecting clip for connecting a pair of joints (50,60) which are arranged to butt against each other at a flange portion (52,62) of the joints, holding the butted flange portions therein, comprising:
a bent plate (21) made of spring material which forms the joint connecting clip body,
the bent plate comprising
gripping portions (10) arranged to surround and hold the flange portions of the joints therebetween by elastic deformation of the bent plate of spring material,
engagement portions (12,13) to engage with the outer peripheries of the flange portions when the gripping portions surround and hold the flange portions, and
a pair of mounting holes (24,214,215) provided above the gripping portions; and
a pair of handling members (22,23) which are respectively inserted and mounted in the mounting holes detachably, for opening the gripping portions by a pinching operation thereon with only-one-direction access from the upside of the gripping portions.

3. The joint connecting clip according to claim 1, wherein the joint connecting clip further comprises open-operation obstructing means (14) for obstructing opening operation of the gripping portions.

4. The joint connecting clip according to claim 3, wherein the open-operation obstructing means has
a set of engagement holes (15,16) which are provided in the upper end portions of the handling portions so as to face to each other, and
an insertion device (17) inserted between the upper end portions of the handling portions, the insertion device comprising a plate portion (170), a fixed protrusion (171) formed so as to project from one end of the plate portion, a sliding protrusion (172) provided so as to project from or withdraw in the other end of the plate portion; and forcing means (177) for forcing the sliding protrusion in a direction such that the sliding protrusion is projected to the outside from the other end portion of the plate portion,
the sliding protrusion and the fixed protrusion being respectively inserted into the engagement holes, and the sliding protrusion being locked in this state, for obstructing opening operation of the gripping portions.

5. The joint connecting clip according to claim 3, wherein
the open-operation obstructing means has a set of locking convex portions (18,19) which are provided in the upper end portions of the handling portions and face to each other; and
an insertion member (20) inserted between the upper end portions of the handling portions, and
the insertion member has a construction such that both ends of a plate spring material (200) are bent in the same direction, and both bent portions are provided with locking concave portions (202) which are concaved so as to match the shapes of the locking convex portions, and the locking concave portions are fitted on the locking convex portions by deflecting deformation of the bent portions, so that opening operation of the gripping portions is obstructed.

6. The joint connecting clip according to claim 2, wherein
a plurality of sprockets are formed on the outer peripheral surfaces of the flange portions, and
the engagement portion has two opening holes (121,122) which is divided by a bridge (120), each of the opening holes engaging with a pair of sprockets (56A, 64A) respectively formed on peripheries of the flange portions, and the bridge engaging with the concave portions (54B,64B) between the adjacent sprockets on the flange, for preventing joint relative turning.

7. The joint connecting clip according to claim 2, wherein there is provided a lock screw (217) for fixedly locking the joint connecting clip to the joint side.

8. A joint connecting structure in which a first joint (50) having a flange portion (52) on the outer peripheral surface and a second joint (60) having a flange portion (62) on the outer peripheral surface are connected to each other so that
the flange portions are butted against each other, wherein the joint connecting structure has a joint connecting clip (1) for fixing the flange portions in a state in which the flange portions are butted against each other,
the joint connecting clip comprises:
gripping portions (10) which are closed so as to hold the flange portions therebetween from outer periphery both sides;
engagement portions (12) with which the outer peripheral portions of the flange portions engage, at least one of the engage portions having two opening holes (121,122) which is divided by a bar portion (120), each of the opening holes engaging with a pair of sprockets (56A,64A) respectively formed on peripheries of the flange portions, and the bridge engaging with the concave portions (56B,64B) between the adjacent sprockets on the flange, for preventing joint relative turning;
forcing means (5) for always forcing the gripping portions in the closing direction; and
a pair of handling portions (11) which are integrally provided above the gripping portions, for opening the gripping portions apart from the flange portions by a pinching operation with access of only one direction from the upside of the gripping portions.

9. A joint connecting structure in which a first joint (50) having a flange portion (52) on the outer peripheral surface and a second joint (60) having a flange portion (62) on the outer peripheral surface are connected to each other so that the flange portions are butted against each other, wherein
the joint connecting structure has a joint connecting clip (1) for fixing the flange portions in a state in which the flange portions are butted against each other,
the joint connecting clip is formed by bending a plate (21) made of spring material, and comprises:
gripping portions (10) which are closed so as to hold the flange portions therebetween from outer periphery both sides by elastic deformation of the plate spring material;
an engagement portion (12) with which the outer peripheral portions of the flange portions engage when the gripping portions are closed;
a pair of mounting holes (24,214,215) provided above the gripping portions; and
a pair of handling members (22,23) which are insertedly mounted in the paired mounting holes detachably, for opening the gripping portions with access of only one direction from the upside of the gripping portions by a pinching operation.

10. The joint connecting structure according to claim 8, wherein the joint connecting clip further comprises open-operation obstructing means (14) for obstructing opening operation of the gripping portions.

11. The joint connecting clip according to claim 10, wherein
the open-operation obstructing means has a set of engagement holes (15,16) which are provided in the upper end portions of the handling portions so as to face to each other; and
an insertion device (17) inserted between the upper end portions of the handling portions, and
the insertion device comprises a plate portion (170), a fixed protrusion (171) formed so as to project from one end of the plate portion, a sliding protrusion (172) provided so as to project from or withdraw in the other end of the plate portion; and forcing means (177) for forcing the sliding protrusion in a direction such that the sliding protrusion is projected to the outside from the other end of the plate portion, the sliding protrusion and the fixed protrusion being respectively inserted into the engagement holes, and the sliding protrusion being locked in this state, for obstructing opening operation of the gripping portions.

12. The joint connecting structure according to claim 10, wherein
the open-operation obstructing means has a set of locking convex portions (18,19) which are provided in the upper end portions of the handling portions and face to each other; and
an insertion member (20) inserted between the upper end portions of the handling portions, and
the insertion member has a construction such that both ends of a plate made of spring material are bent in the same direction, and both bent portions are provided with locking concave portions (202) which are concaved so as to match the shapes of the locking convex portions, and when opening operation of the gripping portions is obstructed, the locking concave portions are fitted on the locking convex portions by deflecting deformation of the bent portions.

13. The joint connecting structure according to claim 9, wherein
a plurality of sprockets (56,64) are formed on the outer peripheral surfaces of the flange portions, and
the engagement portion has two opening holes (121,122) divided by a bridge (120), and has a construction such that of the sprockets, at least any one of convex portions of the sprockets engages with one opening hole (121); an upper convex portion adjacent to the engaging convex portion engages with the other opening hole (122); and the bridge engages with the concave portion between the upper and lower convex portions engaging with the opening holes, by which the turning of the first and second joints is prevented.

14. The joint connecting structure according to claim 9, wherein there is provided a lock screw (217) for fixedly locking the joint connecting clip to the joint side.
